(19) United States
(12) Patent Application Publication
(10) Pub. No.: US 2025/0219371 A1
(43) Pub. Date: Jul. 3, 2025

(54) ELECTRICAL SWITCH PLATE COVER WITH REPLACEABLE INDICIA INSERTS

(71) Applicant: Thomas P. Cox, Carmel, IN (US)

(72) Inventor: Thomas P. Cox, Carmel, IN (US)

(21) Appl. No.: 18/295,634

(22) Filed: Apr. 4, 2023

Related U.S. Application Data
(60) Provisional application No. 63/327,741, filed on Apr. 5, 2022.

(51) Int. Cl. H02G 3/08

(52) U.S. Cl. CPC H02G 3/081

(57) ABSTRACT

A cover plate for an electrical switch includes a frame and an identifying member The frame is a plate-like frame member having a first window sized and positioned for receiving at least a portion of the electrical switch, and a second window sized and configured for receiving the identifying member. The identifying member is a plate-like member formed separately from the frame member. The identifying member has a front surface and a rear surface. An indicia is placeable on the front surface and a frame engaging member is provided that is configured for removably engaging the frame member to secure the identifying member to the frame member.

### PRIORITY STATEMENT

This application claims benefit of U.S. provisional patent application No. 63/327,741, which was filed on 5 Apr. 2022, by inventor Thomas Cox for an Electrical Switch Plate Cover with Replaceable Indicia Inserts, which provisional application is fully incorporated herein by reference.

### I. TECHNICAL FIELD

The present invention relates to electrical switches and, more particularly, to cover plates with replaceable indicia inserts that are usable in connection with electrical switches, such as light switches in a building, such as a residential or commercial facility.

### II. BACKGROUND

Electrical switches have been in existence since buildings first became electrified in the 19^{th} century. Although the date of their first use is not known, switches are typically used in connection with a switch plate cover. Most switch plate covers are made of plastic or metal, and are generally planar, or plate-like. They usually have an area that is large enough to cover the hole in the drywall into which the light switch is placed. By using a cover plate over a light switch, a relatively ugly drywall hole and switch is replaced with a smooth, decorative surface. The light switch cover can include ornamental features on its face, such as scrolls, levels and decorative appliques.

Although light switch cover plates are used in connection with light switches probably more than any other devices, electrical device switches and their respective cover plates are used in connection with a plurality of other electrically-operated devices that may be found in a building. For example, light-switch type electrical switches are used to control a variety of devices such as garbage disposals, fans, fire places, landscape lighting, machinery, electrical outlets and drapery.

Additionally, an electrical switch that is placed in one room, may often be used to control an electrically operated device in another room, thus making the function of the particular light switch somewhat difficult to determine. For example, a light switch in a garage may be used to control a light in an attic. Also, a switch adjacent to an exterior door may be used to control the operation of an outdoor flood light, or an outdoor light mounted on a post.

Given the large number of electrical devices in a typical building it is not unusual for a building to contain a large number of electrical switches. This large number of switches can easily lead to confusion, forcing the owner to operate several switches before locating the correct one. For example, in the bathroom of one known house, there exists seven different light switches to control about five different sets of lights, along with a fan, a heater, and a jet tub.

In view of these problems, it would be helpful if one could label each switch, so that one would be able to view the switch label to quickly determine which electrical device is controlled by the particular switch.

One way to accomplish this is through the use of an adhesive backed label that is applied to the switch plate cover. For example, one can use a Dymo® tape which is a printable tape that has an adhesive backed surface that can adhesively adhere to the front surface of a switch cover plate.

Although the use of such Dymo® tape labels is capable of performing its intended function in a workmanlike manner, room for improvement exists. In particular, room for improvement exists in creating a more permanent and more aesthetically pleasing indicia member than the above-mentioned Dymo® tape.

One objective of the present invention is to provide such an improved labeling system.

### III. SUMMARY OF THE INVENTION

In accordance with the present invention, a cover plate for an electrical switch includes a frame and an identifying member The frame comprises a plate-like frame member having a first window sized and positioned for receiving at least a portion of the electrical switch, and a second window sized and configured for receiving the identifying member. The identifying member is a plate-like member formed separately from the frame member. The identifying member has a front surface and a rear surface. An indicia is placeable on the front surface of the identifying member, and a frame engaging member is provided that is configured for removably engaging the frame member to secure the identifying member to the frame member.

Preferably, a pair of cover engaging legs extend rearwardly from the rear surface of the identifying member. The legs comprise a pair of tab members having frame member engaging surfaces. The frame member engaging surfaces are capable of engaging a rear surface of the frame member for removably coupling the identifying member to the light switch cover plate.

Most preferably, the frame member engaging legs include a beveled, radially outwardly facing lower portion that terminates at its upper (proximal) end in a generally horizontally disposed frame member engaging portion. The beveled portion helps the legs move radially inwardly as the identifying member is pushed into the second window.

In another preferred embodiment, the identifying member comprises a one piece member having an indicia formed integrally with the identifying member and comprising at least one readable character. The second window may include a pair of slots for receiving the frame engaging member, and the frame engaging member includes a pair of tab members sized and configured for being received in the slots.

In another preferred embodiment, the identifying member includes a first end and a second end, and the tab members comprise a first tab member adjacent to the first end, and a second tab member disposed adjacent the second end.

### IV. BRIEF DESCRIPTION OF THE DRAWINGS

FIG. 1 is a front view of identifying member containing cover of the present invention for use with a light within an electrical switch;

FIG. 1A is a perspective view of a toggle switch of the type that might be used with, inter alia, the cover shown in FIGS. 1-18;

FIG. 1B is a perspective view of a widened, rocker-type switch of the type that might be used in connection with the covers shown in FIGS. 19-30;

FIG. 2 is a front view of the cover of FIG. 1 with the identifying member removed;

FIG. 3 is a rear view of the switch cover of FIG. 2;

FIG. 4 is a right, or first side, view of the cover of the FIG. 2;

FIG. 5 is a left, or second side, view of the cover of FIG. 2;

FIG. 6 is a bottom view of the cover of FIG. 2;

FIG. 7 is a top view of the cover of FIG. 2;

FIG. 8 is a front-biased perspective view of the cover of FIG. 2;

FIG. 9 is a rear-biased perspective view of the cover of FIG. 2;

FIG. 10 is a perspective front view of an alternate embodiment cover plate that is designed for a pair or vertically movable toggle type electric switches;

FIG. 11 is a front view of the cover of FIG. 10;

FIG. 12 is a rear view of the cover of FIG. 10;

FIG. 13 is a front view of another alternate embodiment of the present invention, showing a cover designed for receiving three generally vertically movable toggle type electrical switches;

FIG. 14 is a rear view of the cover member of FIG. 13;

FIG. 15 is a front view of a switch cover of the present invention that is designed to receive four vertically oriented toggle switches;

FIG. 16 is a rear view of the cover of FIG. 15;

FIG. 17 is a front perspective view of a cover of the present invention designed for use with a five “gang” array of vertically oriented toggle switches;

FIG. 18 is a rear view of the cover of FIG. 17;

FIG. 19 is a front perspective view of a single switch cover plate of the present invention intended for use with a wider switch, such as a rocker switch, a wide-type dimmer switch, a selector light switch and illuminated switch, etc., many of which are described at www.electronicshub.org/different-types-of-light-switches/the disclosure of which is incorporated herein by reference;

FIG. 20 is a rear view of the cover of FIG. 19;

FIG. 21 is a front perspective view of a horizontally-oriented cover use with a wide switch;

FIG. 22 is a rear view of the cover of FIG. 21;

FIG. 23 is a front view of a cover of the present invention designed for use with a pair of vertically-oriented wide switches;

FIG. 24 is a rear view of the cover of FIG. 23;

FIG. 25 is a front view of a cover of the present invention designed for use with three vertically-oriented wide switches;

FIG. 26 is a rear view of the cover of FIG. 25;

FIG. 27 is a front perspective view of a cover of the present invention designed for use with a four-gang, vertically-oriented wide switch array;

FIG. 28 is a rear view of the cover of FIG. 27;

FIG. 29 is a front perspective view of a cover of the present invention designed for a five-gang array of wide switches;

FIG. 30 is a rear view of the cover of FIG. 29;

FIG. 31 is a front perspective view of a cover of the present invention designed to work with a two-gang switch, wherein the first switch is a relatively thin toggle-type switch, and the second switch is a wide-type switch;

FIG. 32 is a rear perspective view of a cover of FIG. 31;

FIG. 33 is a front perspective view of a cover of FIG. 31;

FIG. 34 is a front perspective view of a cover of the present invention designed for use with a three-gang switch, wherein the first switch of the gang is a toggle switch, the second switch is a toggle switch, and the third switch is a wide rocker-type switch;

FIG. 35 is a rear perspective view of the cover of FIG. 34;

FIG. 36 is a front perspective view of a cover of the present invention designed for use with a four gang switch, wherein the first three switches are relatively narrower toggle switches, and the fourth switch is a relatively wider rocker switch;

FIG. 37 is a rear perspective of the view of the cover of FIG. 36;

FIG. 38 is a front perspective view of a cover of the present invention designed for use with a five-gang switch array, wherein the first four switches are toggle switches and the fifth switch is a wide switch;

FIG. 39 is a rear perspective of the view of the cover of FIG. 38;

FIGS. 40A-40E are front views of an array of different covers, showing a possible arrangement of mold cavities within a single mold in which the covers of the present invention may be injection molded;

FIG. 41A is a front view of the cover of the present invention shown in FIGS. 1-8;

FIG. 41B is a sectional view, taken along lines a-a of FIG. 41A;

FIG. 41C is a rear view of the cover of FIG. 41A;

FIG. 41D is a sectional view taken along lines C-C of FIG. 41C;

FIG. 41E is an enlarged sectional view of the area encircled by Circle E of FIG. 41D;

FIG. 42A is a front view of the cover shown in FIGS. 19-22;

FIG. 42B is a sectional view, taken along the lines of b-b of FIG. 42A;

FIG. 42C is a rear view of the cover of 42a;

FIG. 43A is a front, partly broken front view of a multi-gang toggle switch cover, illustrating the dimensions of a cover typical to single, two-gang, three-gang, four-gang, and five-gang covers used with toggle switches;

FIG. 43B is a left side view of the cover of FIG. 43A;

FIG. 44 is a front perspective view of an identifying member of the present invention;

FIG. 45 is a rear perspective view the plate-like identifying member of FIG. 44;

FIG. 46 is a front view thereof;

FIG. 47 is a top view thereof;

FIG. 48 is a bottom view thereof;

FIG. 49 is a rear view thereof;

FIG. 50 is a left side view thereof;

FIG. 51 is a right side view thereof;

FIG. 52 is a front and bottom perspective view of an alternate identifying member showing the term “basement” as the indicia;

FIG. 53 is a front perspective view of an alternate identifying member showing the alternate indicia “bathroom” thereon;

FIG. 54 is a bottom and front perspective view of an alternate embodiment identifying member wherein the alternate indicia “bedroom” is shown;

FIG. 55 is a front view of an alternate embodiment identifying member containing the word “chandelier” embossed on the front surface;

FIG. 56 is an array of identifying members showing a variety of different indicia that may be placed on the front of the plate;

FIG. 57A is a front, blueprint view of an exemplary identifying member of the present invention;

FIG. 57B is a bottom view of the identifying member of FIG. 57a;

FIG. 57C is a sectional view taken along lines e-e of FIG. 57a;

FIG. 57D is a detail view taken from area “f” of FIG. 57c;

FIG. 58 is a perspective view of the identifying member of FIG. 57a; and

FIG. 58B is a rear view of the identifying member of FIG. 57a.

### V. DETAILED DESCRIPTION

The description that follows describes, illustrates and exemplifies one or more particular embodiments of the present invention in accordance with its principles. This description is not provided to limit the invention to the embodiment or embodiments described herein, but rather to explain and teach the principles of the invention in such a way to enable one of ordinary skill in the art to understand these principles and, with that understanding, be able to apply them to practice not only the embodiment or embodiments described herein, but also other embodiments that may come to mind in accordance with these principles.

The scope of the present invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing reference numbers, such as, for example, in cases where such labeling facilitates a clearer description. Additionally, the drawings set forth herein are not necessarily drawn to scale, and in some instances proportions may have been exaggerated to more clearly depict certain features. Such labeling and drawing practices do not necessarily implicate an underlying substantive purpose.

Furthermore, certain views are side views which depict only one side of the device (or one set of components of a multi set array of components), but it will be understood that the opposite side and other component sets are preferably identical thereto. The present specification is intended to be taken as a whole and interpreted in accordance with the principles of the present invention as taught herein and understood by one of ordinary skill in the art.

It should also be appreciated that unless otherwise indicated, terms that relate to directions and placement, including, but not limited to terms such as front, rear, distal, proximal, radial, axial, forward, rearward, above, below, under, over, in front of, behind, and alongside of are provided for illustration to help the reader better visualize the relative placement of the components, and are not intended to be limiting.

For example, the designation of a particular end or portion an object as being proximal is in most cases arbitrary, and is employed to distinguish its placement from the other end, which may be labeled as distal. Nonetheless, unless otherwise indicated, there is no reason that the formerly labeled distal end could not be labeled as the proximal end and vice versa.

Similarly, terms such as radial are employed to distinguish a particular direction from another direction, such as axial, but should not be limited to an interpretation where radial is disposed exactly 90° from axial. Rather, radial should be interpreted as any direction that his within 45° of a true radial that is perpendicular to axial. Similarly, axial should be interpreted as being any direction that is within 45° of a true axial that is perpendicular to radial.

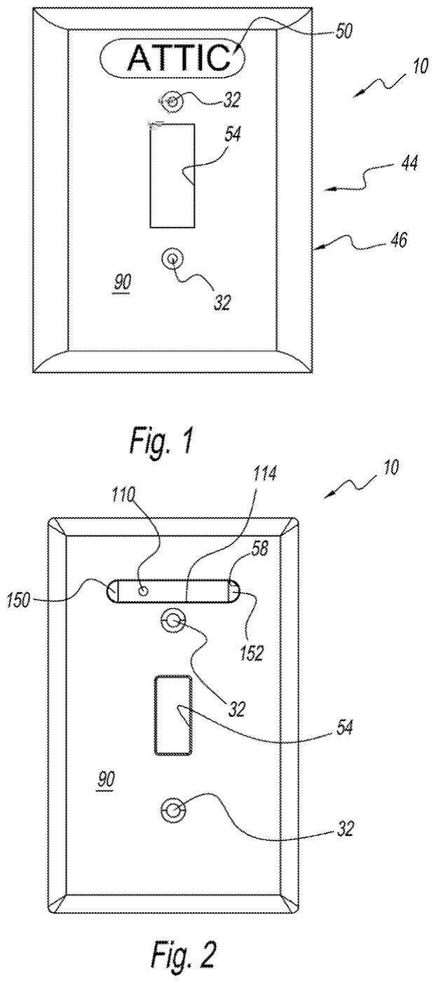

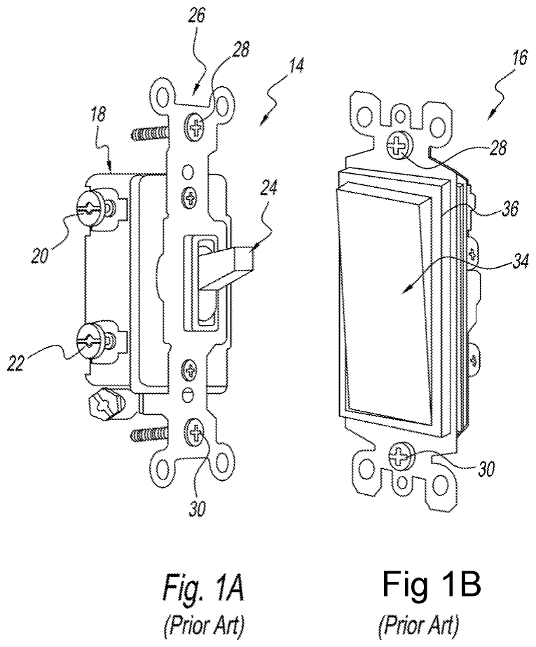

The cover of the present invention is shown in the drawings. Turning first to FIG. 1, the cover plate 10 of the present invention is shown as being coupled to a switch, here shown as a single-gang electrical toggle switch 14. The remainder of the drawings show primarily covers or plates, but do not show the switch therein.

However, exemplary switches are shown in FIGS. 1A and 1B. FIG. 1A shows a typical toggle switch 14 that includes a housing 18 having first 20 and second 22 terminals. The switch 14 shown is a single pole toggle switch 14, and only includes a first 20 and second 22 terminals. Switch 16 is a single pole rocker-type switch.

In contrast, a two pole toggle switch (not shown) will also have third and fourth terminals. Through this arrangement, a two pole toggle switch can operate two devices, whereas a single pole toggle switch can operate only one device or outlet.

The switch 14 includes a housing 18 for containing the actual switching components, a toggle switch lever 24 for moving the switch between an “on” and “off” position, and a metal frame 26 for coupling the switch to a fixed member, such as a two-by-four, electrical box, or the like. The switches 14, 16 shown in FIGS. 1A and 1B include a pair of screws 28, 30 that are inserted through apertures. The first 28 and second 30 screws shown in each of FIGS. 1A and 1B are used to secure the cover of the present invention to the switches 14, 16 by passing the screws through aligned screw receiving apertures 32 formed in the cover plate 10.

From a functionality standpoint, the rocker type wide switch 16 of FIG. 1B operates virtually identically to the toggle switch 14 of FIG. 1A. The primary difference is that a different type of switching lever and switch mechanism is employed.

In the wide rocker switch 16 of FIG. 1B, a flatter, wider switch-moving member 34 is employed. Although each of the two switches 14, 16 has its various functional and aesthetic benefits and drawbacks, the primary importance of the two types of switches to the present invention is that the size of the toggle switch lever 24 and housing 18 is much smaller than the size of the rocker switch lever 34 and housing 36, thus requiring the present invention cover plate 10 to have different sized switch receiving windows 54 to accommodate the different sized switch levers and frames.

Importantly, the toggle type switch 14 and rocker type switch 16 are the primary types of switches used in most residential, commercial, and office buildings. However, other switches do exist, which are often sized to be accommodated into standard sized windows of cover plates.

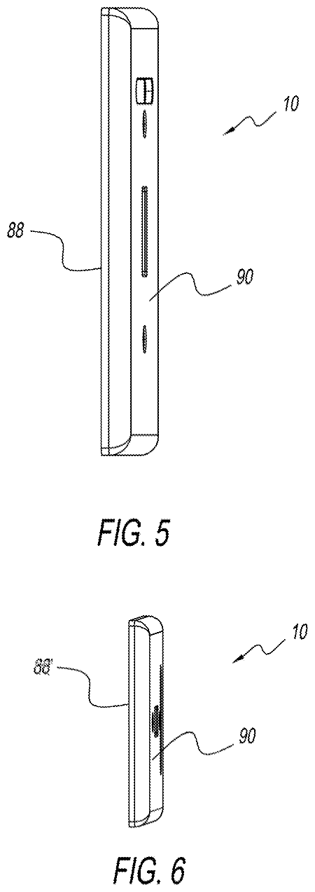

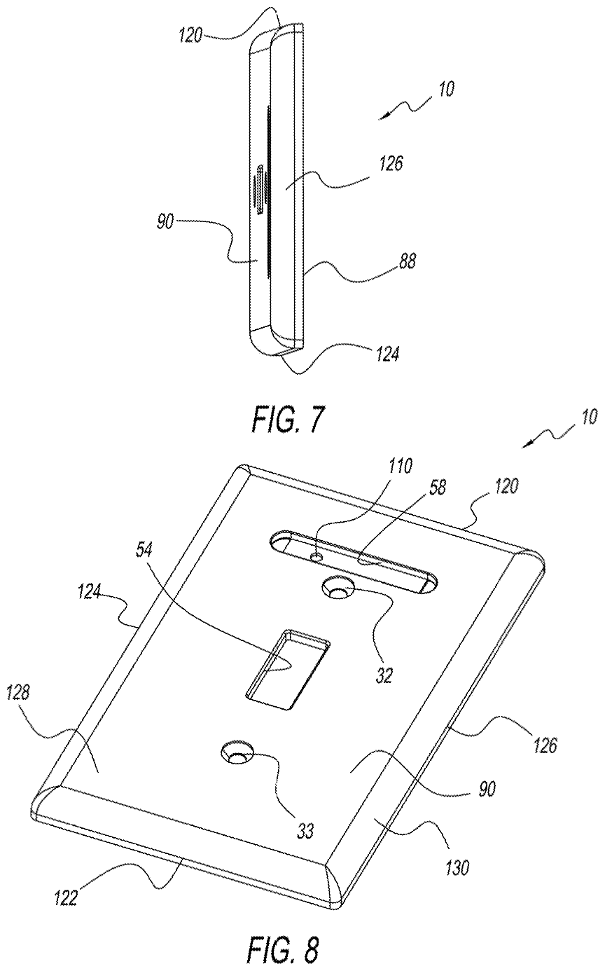

Turning now to FIGS. 1-8, a cover plate 10 for an electrical switch 14 includes a frame 44 comprising a frame member 46 and an identifying member 50. The frame member 44 is plate-like and has a first window 54 sized and positioned for receiving at least a portion of the electrical switch 14, and a second window 58 sized and configured for receiving the identifying member 48.

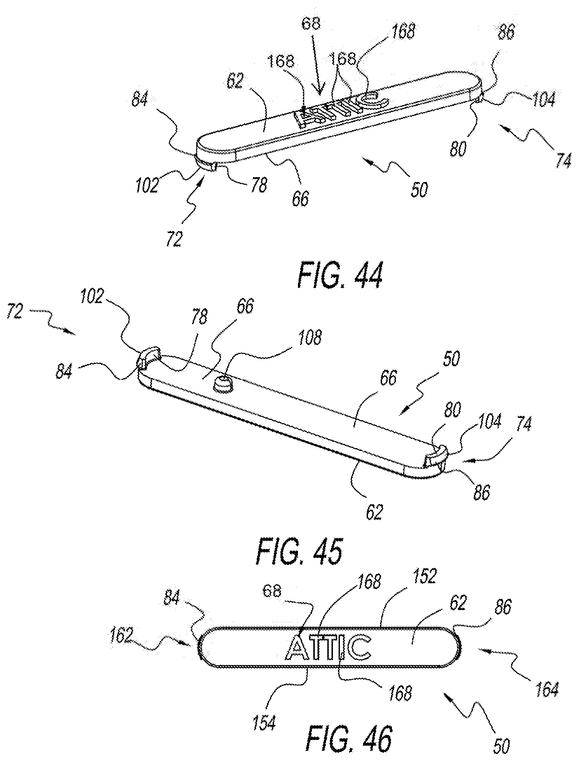

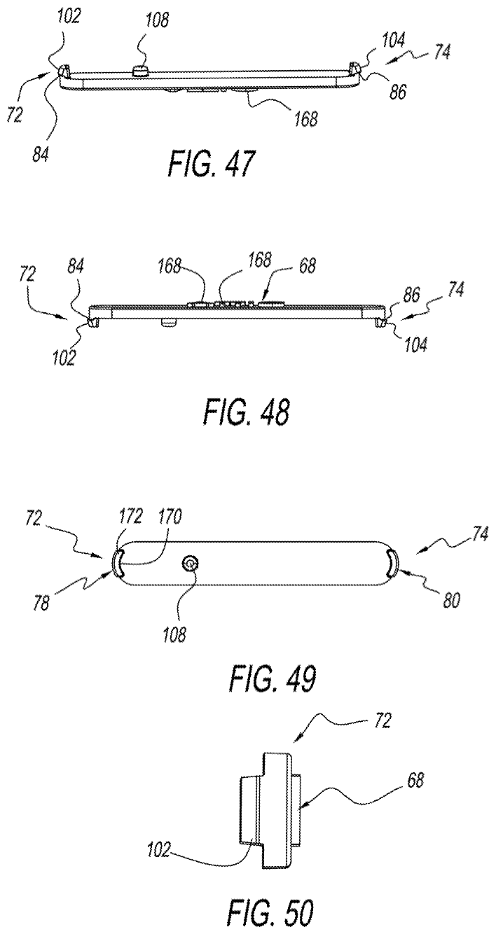

As best shown in FIGS. 44-50, the identifying member 50 is a plate-like member formed separately from the frame member 46. The identifying member 48 has a front surface 62 and a rear surface 66. An indicia 68 is placeable on the front surface 62 of the identifying member 50, and a frame engaging member 72, 74 is provided that is configured for removably engaging the frame member 46 to secure the identifying member 50 to the frame member 46.

The frame engaging member includes a first frame engaging tab member 72 and a second frame engaging tab member 74. The first 72 and second 76 frame engaging tab members each includes frame engaging leg 78, 80 that extends rearwardly from the rear surface 66. The legs 78, 80 comprise a pair of tab members having frame engaging surfaces 84, 86.

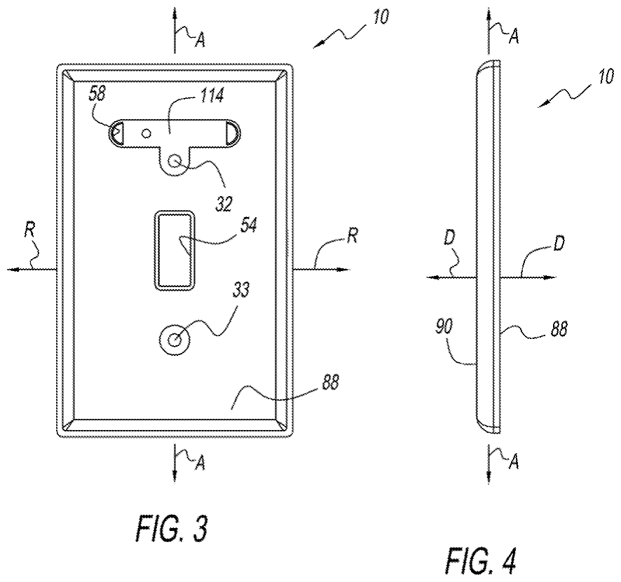

The frame engaging surfaces 84, 86 are sized and positioned for engaging an interiorly facing rear surface 88 (FIGS. 3, 4) of the frame member 46 for removably coupling the identifying member 50 to the frame member 46. The frame member 46 also includes an exteriorly facing front surface. The light switch cover of the present invention comprises a generally thin, injection-molded plastic device that includes two primary members, including the frame member 46 and the removable identifying member 50.

The identifying member 50 includes a first end 96 and a second end 98. The first end and second end frame engaging tabs 72, 74 include the first tab 72 being disposed adjacent to the first end 96 of the identifying member 50, and the second tab member 74 being disposed adjacent to the second end 98 of the identifying member 50. The first tab 72 is disposed closer to the first end 96 than to the second end 98, and the second tab 74 is disposed closer to the second end 98 than to the first end 96.

The first tab member 72 includes a beveled radially outward facing surface 102, and the second tab 74 also includes a beveled radially outwardly facing surface 104. Each of the tabs 72, 74 also include a forwardly facing frame member engaging surface 84, 86 that is sized and position for engaging a rearwardly facing surface 88 of the frame member 46. The engagement of the beveled surfaces 102, 104 with the frame member 46 moves the first and second tabs 72, 74 radially inwardly as the identifying member 50 is pushed into engagement with the second window.

An aligning pin 108 extends outwardly from the rear surface of the identifying member 50 the aligning pin 108 is sized and positioned to be received by a pin receiving aperture 110 that is formed in a backing plate 114 which comprises part of the second window 58 of the cover plate 10.

The light switch cover plate 10 of the present invention comprises a generally thin, injection-molded plastic device that comprises a frame 44 includes two primary members, including the frame member 46 and the removable identifying member 56.

The frame member includes a front surface 90 and a rear surface 88. Additionally, the front surface 90 is generally rectangular in configuration, although in theory it could include any shape that was large enough to accommodate the switch 14, 16, the plate 10, and the first and second countersunk screw receiving apertures 32, 33, as these are the dimensions that help to define the cover, and which are generally required to have in the cover so that it may both cover the drywall hole in which the switches are mounted 14, 16, while also making the cover 10 mountable to existing switches 14, 16.

The cover frame member 46 includes a front surface 90 and a rear surface 88. For direction purposes, it can also be assumed that the cover has an axial or longitudinal direction “A” as shown in FIG. 3, and a radial or lateral direction “R” that is generally perpendicular to the axial direction “A” and a depth direction D (FIG. 4).

As used in this application, directional indicators such as front, back, side, axial, radial longitudinal, lateral, depth, height, and weight are understood to be arbitrary selections that are given primarily to help the reader of this application understand the device better, and are not meant as terms of limitation. For example, when one item is referred to as being disposed radially of a second item, it should be understood that this does not require that the first item be disposed at an exact, perpendicular angle to the axial direction but, rather, that it is generally “to the side of” the second item. Once again, the terms “axial”, “radial”, “front”, and “back” are used more to help the user understand the invention, than as actual indicators of features, or as limitations on the scope of coverage accorded to the claims of the instant invention.

The cover also includes a top surface, a bottom surface, a first side surface, and a second side surface. The top edge and bottom edge surfaces 120, 122 are placed in an opposed relation, as are the first 124 and second 126 side edge surfaces.

Many of the cover plate frame members 46 include central portions 128 of the front surface 90 that are generally planar. However, the frame member also includes a perimetral frame portion 130, which comprises a radius curve, similar to a “quarter round” (FIG. 8).

The first and second countersunk screw receiving apertures 32, 33 are placed respectively above and below the first switch receiving window 54. The apertures 32, 33 are sized and configured to receive screw 28, 30. When the screws 28, 30 are inserted into the receiving apertures 32, 33, they will pass through the apertures 32, 33, and into the screw receiving aperture of the switches 14, 16 that are shown in FIGS. 1A and 1B.

The switch receiving first window 54 is placed centrally on the cover 10, and is sized and configured for receiving the switch 14, 16, including the frame that surrounds the switch 14, 16. This is shown in FIG. 1. The size of the actual aperture 54 for a toggle switch 14 is better shown in FIG. 2.

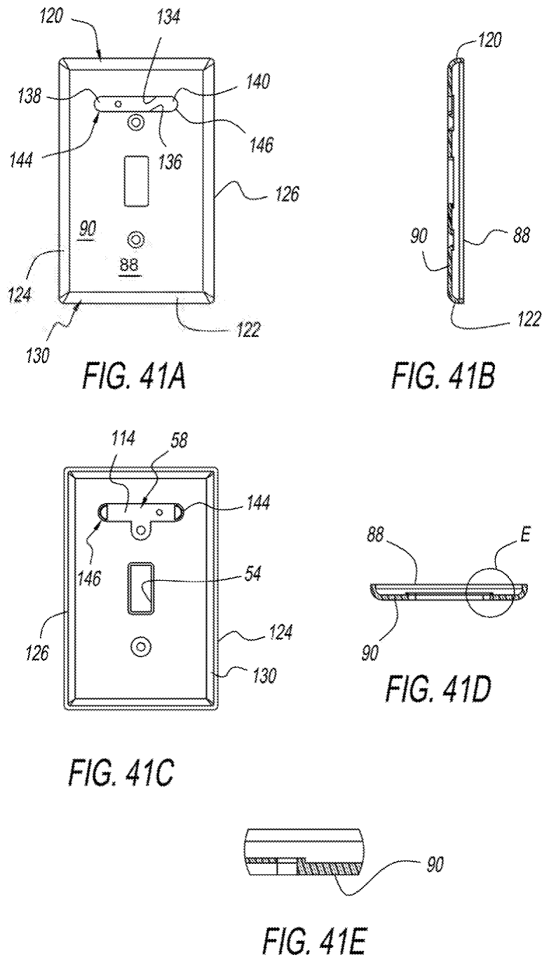

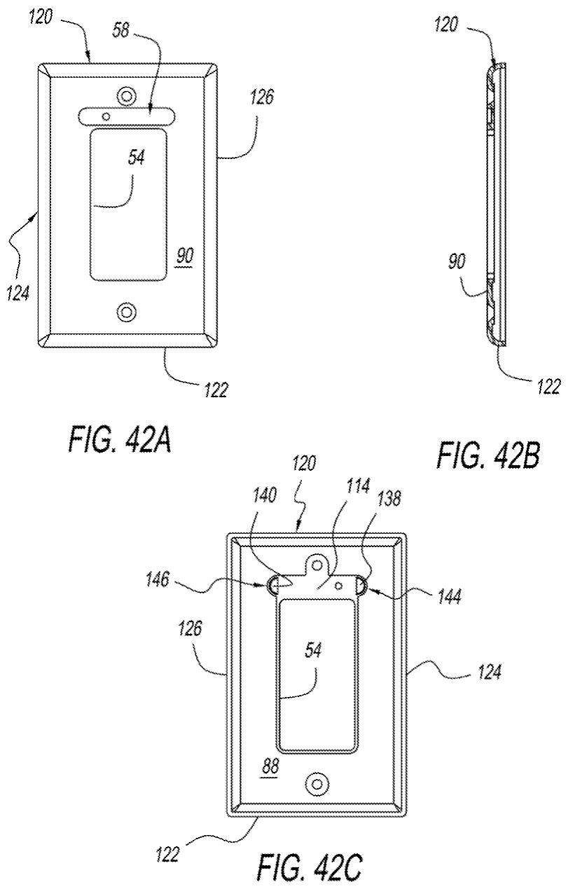

A second window 58 comprising an identifying member 50 receiving aperture 58 is disposed above the first screw receiving hole aperture 32. The identifying member 50 receiving 54 aperture is generally paperclip-shaped and includes an upper 134 and lower 138 generally linear wall portion and a first 138 and second 140 semi-cylindrical end portions disposed at the respective first and second ends of the plate receiving aperture (FIGS. 41A-42C).

To a large extent, the identifying member 50 receiving aperture comprises a blind hole, which has a backing wall 114. The backing wall 114 helps to prevent the identifying member 50 from being inserted and passing through the second window 58.

The backing wall 114 is designed so that it provides the identifying member 50 receiving second window 58 with enough depth to receive the identifying member 50 while still being capable of being injection-molded onto the remainder of the cover in a single mold cavity.

Because of the quarter round nature of the perimeter 130 of the frame member 46, and the depth of the identifying member 50, the cover 10 of the present invention has a depth that may be greater than a typical switch cover.

Preferably, the depth of the identifying member 50 receiving aperture 58, when measured from the front facing surface of the backing wall is approximately 0.080 inches to accommodate a backing plate 114 having approximately the same depth. In order to accommodate the backing wall 114 and identifying member 50, the frame member 46 preferably has a depth that is generally greater than the depth found in most plates.

For example, the depth of the cover plate, as shown in FIGS. 42a-42c is approximately 0.305 inches which leaves a rear opening cavity of somewhere about 0.20. As such, the cover plates 10 of the present invention are likely to extend outwardly from most of the wall further than prior art conventional cover plates.

The backing wall member 114 also includes first 150 and second 152 tab receiving apertures, or slots which are not blind apertures but are slots that extend all the way through the plate. As will be discussed in more detail below, the first and second plate receiving slots 150, 152 are sized and configured for receiving the identifying member tabs 72-74 shown at FIG. 44 et seq.

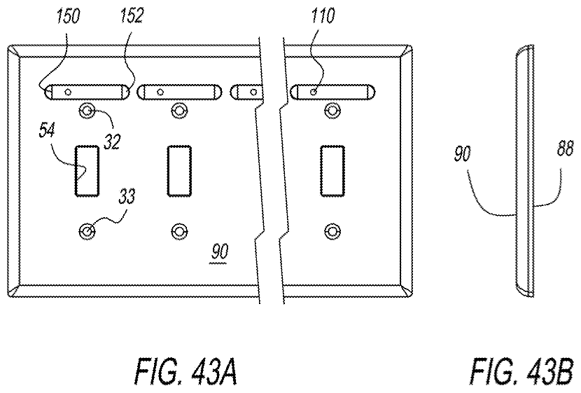

Turning now to FIGS. 42a-43b, blueprint versions of plates are shown. These blueprint drawings are useful insofar as they include exemplary dimensions.

It should be noted that the dimensions shown in these figures are exemplary and that variations in these dimensions are within the scope of the invention. As will also be discussed below, different plates that are shown in the figures have different dimensions since they are designed for being used with multiple gang arrays of switches. Additionally, the depth descriptions can be varied depending on things such as functional and aesthetic consideration.

The size of the switch receiving window 54 will also be likely varied, as shown in the drawings, to accommodate different sizes of switches 14, 16 and their frames.

Although the toggle 24 and rocker 34 switch shown in FIGS. 1A and 1B are the most common types of switches employed, it should be recognized that other sizes of switches exist, and other shapes, such as push button switches, which would likely require a pair of round switch receiving apertures to receive the generally cylindrical “on” switch and the generally cylindrical “off” switch on some such switches.

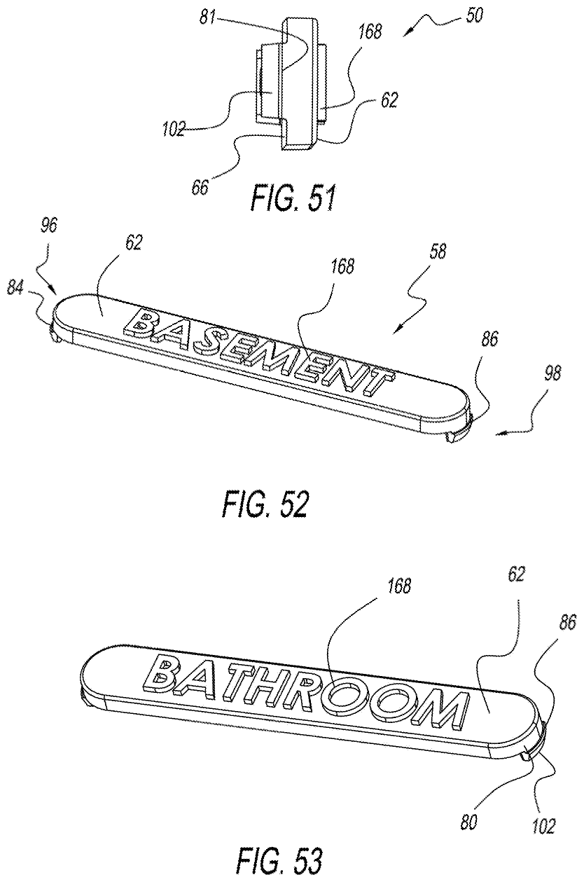

Turning now to FIGS. 44-58B, various identifying members 50 are shown in various views. In particular, FIG. 44 shows a front-bottom perspective view and FIG. 45 shows a rear and top biased perspective view.

The identifying member 50 is removably couplable to the frame member 46. The identifying member 50 is generally paperclip shaped. It has a generally planar top side wall portion 156, and bottom side wall portion 158, and a semi-cylindrical first end wall portion 162 and second end wall portion 164. This “paperclip” shape is often referred to as a race track shape as the overall shape is generally similar to some race tracks such as one in Martinsville, Virginia.

The identifying member 50 includes a front surface 62 and a rear surface 66. The front surface 62 is generally planar, except that it includes an indicia portion 68 that comprises one or more characters 168 that are raised forwardly out of the plane of the front surface 62. The raised letters usually comprise a word which describes the item controlled by the light switch to which the identifying member 50 is attached.

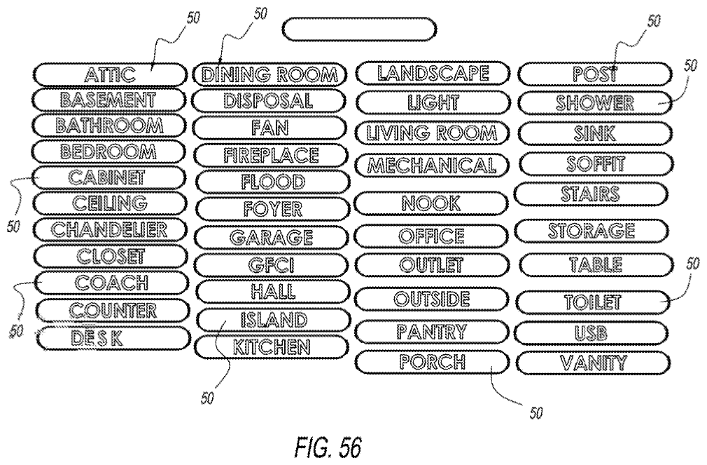

For example, the identifying member 50 of FIG. 44 contains the word “attic” to help inform the user that the light switch that is disposed adjacent to the identifying member 50 that has “attic” thereon controls a light within the attic of the house. As best shown in FIG. 56, the particular indicia can comprise any one of a number of words to describe any one of a number of items or areas that are actuated by the light switch adjacent to the identifying member.

In FIG. 56 you will notice that some of the indicia are directed to spaces, such as attic, basement, bathroom, etc. Others are directed to particular fixtures within a space, such as ceiling and chandelier, vanity and drapes. Others related to various electrical appliances that are operated by the switch, such as USB, garbage disposal, fan, and fireplace.

It will be appreciated that the list shown in FIG. 56 is not exclusive, but rather represents what the applicants expect to be the most common items, spaces, and things that will likely be identified in a residence and controlled by an electrical wall switch.

It will be appreciated that the items on the identifiers would like be very different for identifying members made for specialized applications, such as hotel rooms, bowling alleys, furniture room displays, machine shop areas, cubicle rooms, and the like.

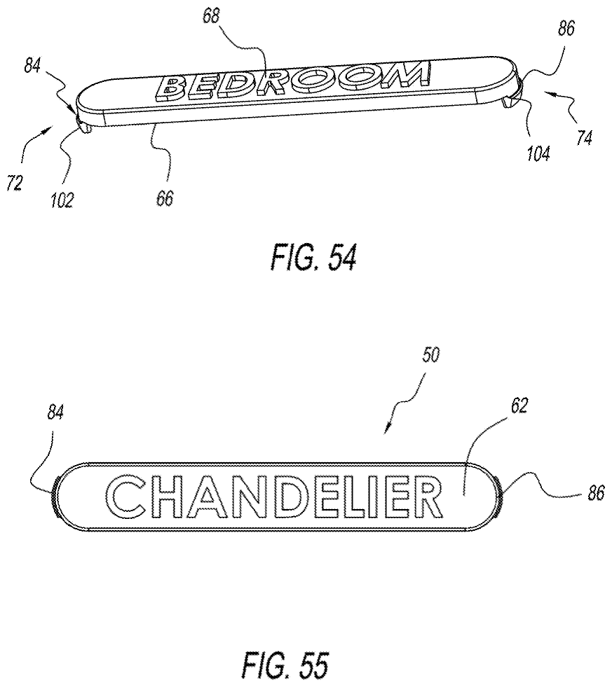

Some exemplary identifying members 50 are shown in other drawings in addition to the attic identifying member of FIG. 44. For example, FIG. 52 shows the identifying member containing the word “basement”; FIG. 53 shows the term “bathroom”; FIG. 54 shows the term “bedroom”; and FIG. 55 shows the term “chandelier”.

Returning to FIGS. 44-50, it will be noted that each of the identifying members 50 include a first frame member 72 which comprises a first engaging leg 78 disposed adjacent to the first end wall portion 162, and a second frame engaging member 74 which comprises a second leg 80 disposed adjacent to the second end wall portion 164. The first and second cover engaging legs 78, 80 each include a partially cylindrical, inwardly facing surface 170, and a leg rearwardly facing surface 172 that is generally planar (FIG. 49).

The frame member engaging legs 78, 80 have outwardly facing surfaces that have two portions. The distal portion generally comprises a beveled, radially outwardly facing distal surface 102. The beveled distal surface 102 has a distal end (adjacent to surface 172) that is disposed more radially inwardly than the proximal end of the beveled distal surface 102 (adjacent to surfaces 84, 86).

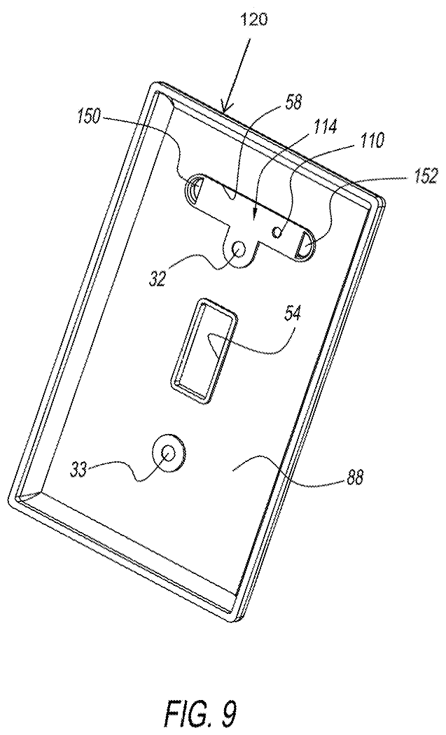

This angled, beveled, distal surface 102 helps the legs 78, 80 move radially inwardly as the beveled surface 102engages and slides inwardly along the rounded interiorly-facing surface of the leg receiving aperture 150, 152 (FIGS. 8, 9). As the identifying member 50 moves in a front-to-back direction, the distal portion of the beveled distal surface 102 can fit interiorly within the first leg receiving aperture 150, and can bend inwardly sufficiently so that the leg 78 can be fully inserted so that the cover engaging surface 84 of the identifying member 50 will be able to engage and rest upon the rear surface cover engaging leg mating surface (FIG. 3). The cover engaging leg mating surface is a portion of the rear surface 88 of the frame member 46, that is disposed just outwardly of the first leg receiving aperture 150.

Viewed another way, the length of the identifying member, when measured between the proximal ends of the beveled distal surfaces 102 of the first and second legs 78, 80, should generally be greater than the distance between the outwardly most points of the first and second leg receiving apertures 150, 152 of the frame member 46. However, the distance between the distal ends of the beveled distal surface 102 should be slightly smaller than the distance between the outer most ends of the first and second leg receiving apertures 150, 152 of the frame member 46.

It will also be noted that the rear surface 66 of the identifying member includes a backing plate 114, engaging pin 108 that is sized and positioned to be insertable into the pin receiving aperture 110 of the backing plate 114 of the frame member 46 (FIG. 2).

To operate the device 10, the identifying member 50 is placed over the front surface 22 of the frame member 46, adjacent to the second window 58 which serves as an identifying member 50 receiving aperture 58. The identifying member 50 is then pushed inwardly toward the rear surface 88 of the frame member 46, so that the first and second frame engaging legs 78, 80 respectively engage the first and second leg-receiving slots 150, 152.

Because of the beveled distal surface 102, the distal end 162, 164 of the legs 78, 80 will fit within the apertures inwardly, and as the identifying member is pushed rearwardly, the legs will be caused to bend, until they are fully inserted through the apertures 150, 152. When fully inserted, the cover engaging surfaces 84, 86 of the first and second cover-engaging legs 78, 80 will mate with and be positioned adjacent to the cover-engaging leg mating surface of the rear surface 88 of the frame member 46. At such point, the identifying member 50 will be fixedly engaged to the frame member 46.

Subsequently, when one wishes to remove the identifying member 46, one can do so by turning over the cover so that the rear 88 of the frame member 46 is exposed, engaging the first and second cover engaging legs 78, 80 with one's fingers and pushing them inwardly to release the engagement of the cover-engaging surface 84, 86 of the identifying member 50 with the identifying member-engaging surface 88 of the frame engaging member. The identifying member 50 is then pushed forwardly to disengage it from the identifying member receiving slots 150, 152 of the cover.

As the back wall engaging pin 108 is just slid into the pin-receiving aperture 110 of the backing plate 114, it will slide into and out of the pin receiving aperture 110 of the backing plate 114 when the identifying member 50 is installed and removed.

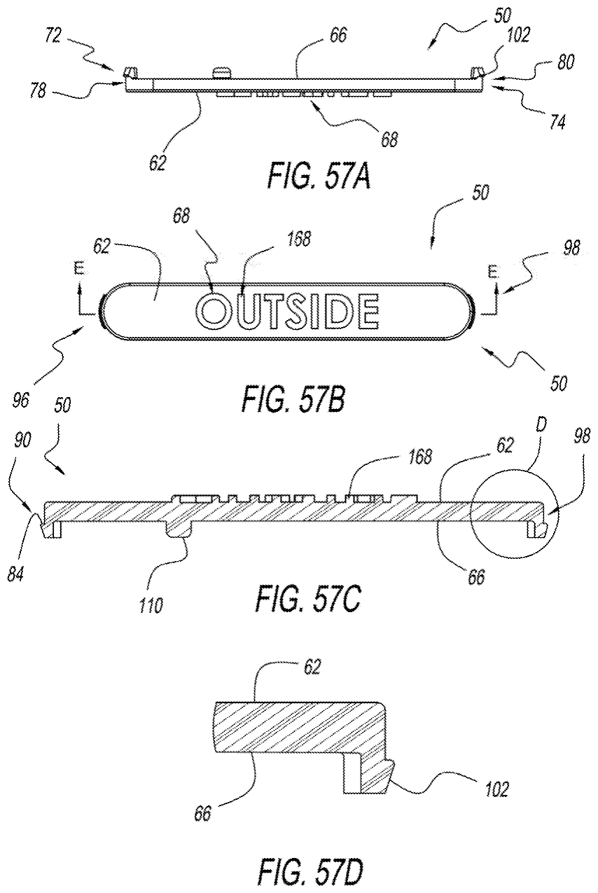

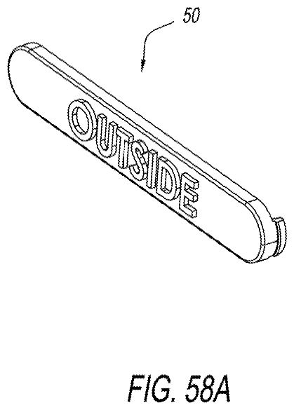

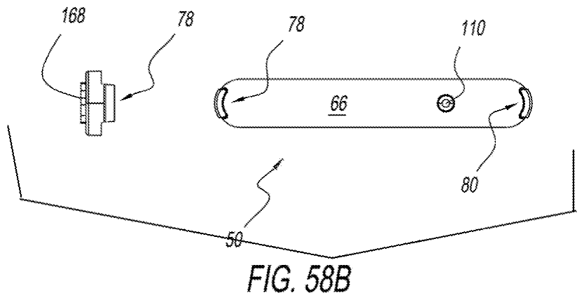

Your attention is next directed to FIGS. 57A-D, and FIGS. 58A, and 58B, which provide blueprint type illustrations of the identifying member 50. These views include dimensions that are useful for understanding the best mode perceived presently of producing the invention.

However, it will be appreciated that these dimensions are merely exemplary and not limiting. Of particular note should be dimensions relating to the height of the pin (57B), the height of the text of the indicia member (0.02 inches at FIG. 57B) and the respective dimensions of the legs that are best shown at FIGS. 57D and 58B).

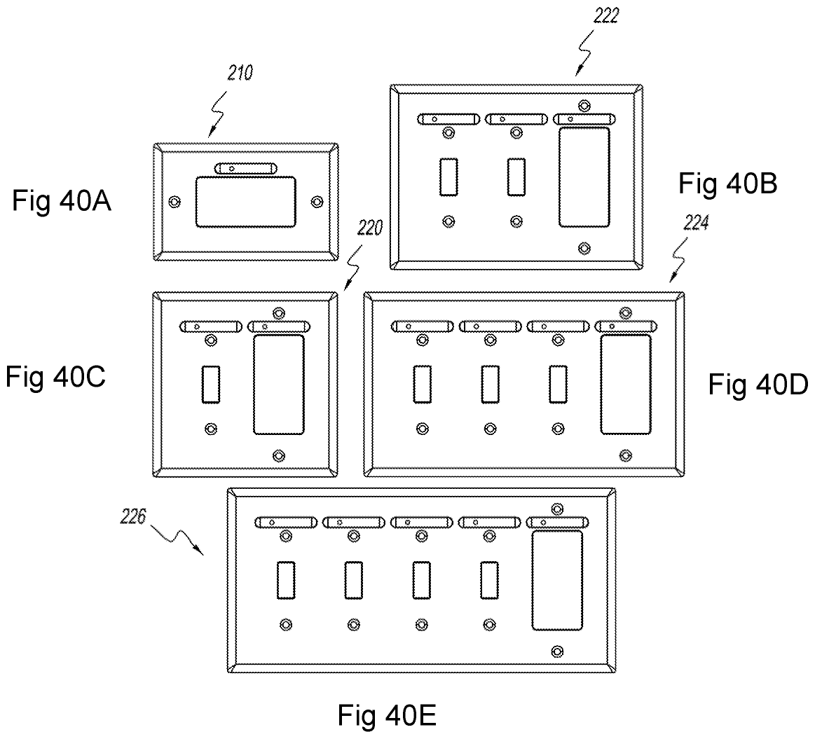

Your attention is next directed to FIGS. 9-40. These figures show the invention being incorporated into a variety of alternate embodiment covers. The primary differences between the covers relates to the number of switch receiving windows they contain and thus number of switches that they are able to accommodate, and the type of switches that they are able to accommodate. Below are short descriptions of the various alternate embodiment cover plates.

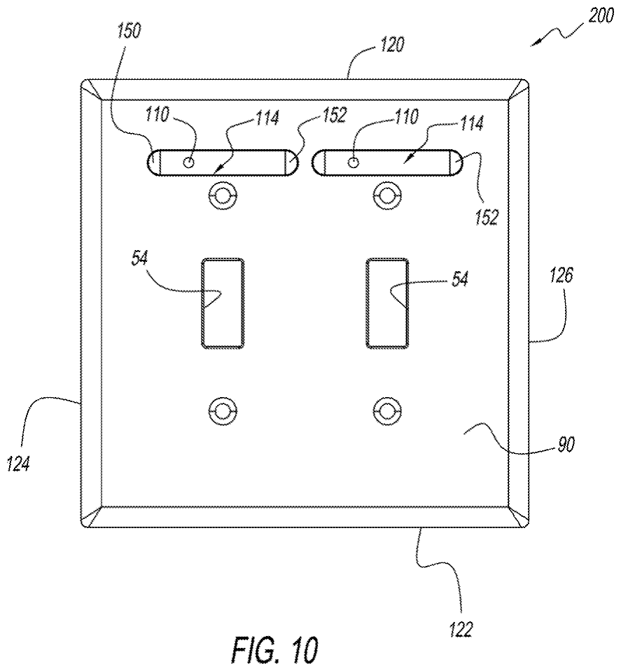

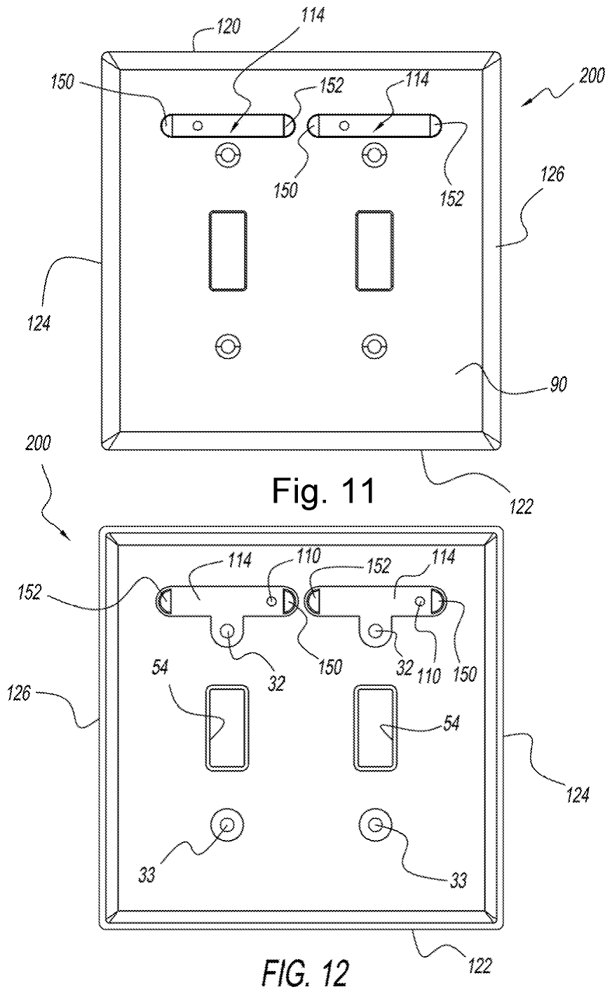

FIG. 10 is a perspective front view of an alternate embodiment cover plate 200 that is designed for a pair or vertically movable toggle type electric switches. FIG. 11 is a front view of the cover plate 200 of FIG. 10; and FIG. 12 is a rear view of the cover plate 200 of FIG. 10.

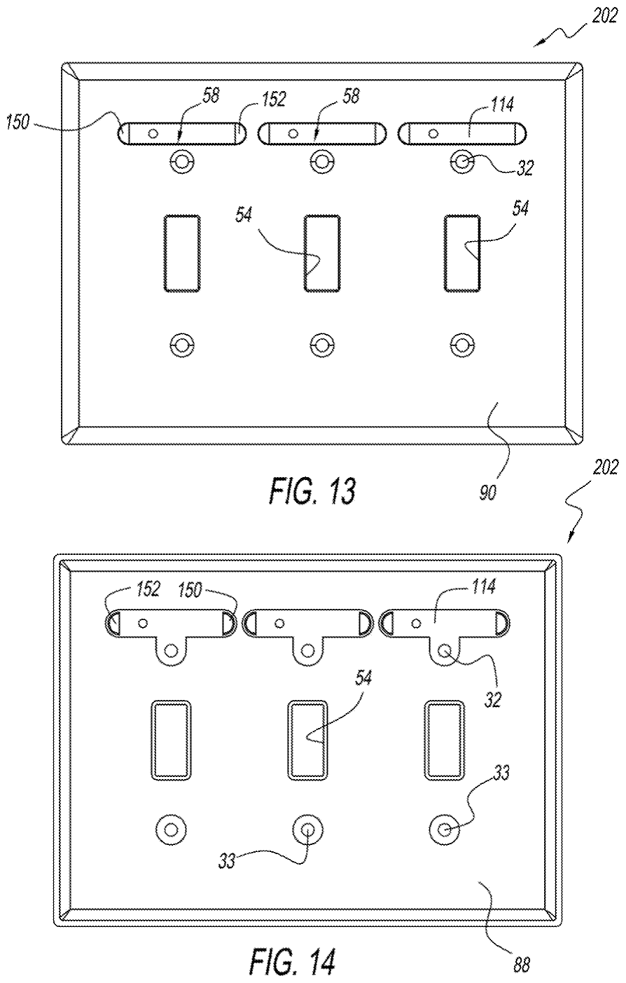

FIG. 13 is a front view of another alternate embodiment cover plate 202 of the present invention, showing a cover 202 designed for receiving three generally vertically movable toggle type electrical switches. FIG. 14 is a rear view of the cover plate 202 of FIG. 13.

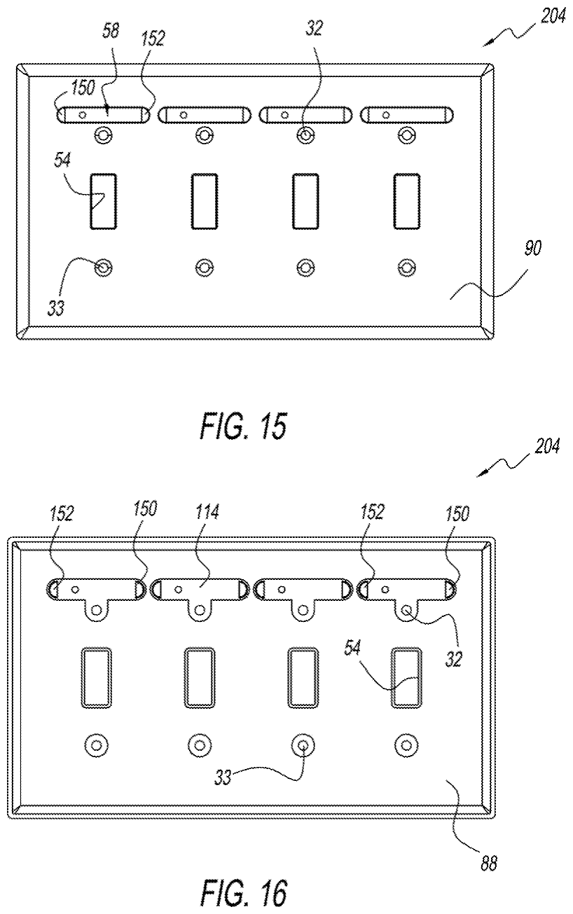

FIG. 15 is a front view of a switch cover plate 204 of the present invention that is designed to receive four vertically oriented toggle switches. FIG. 16 is a rear view of the cover plate 204 of FIG. 15.

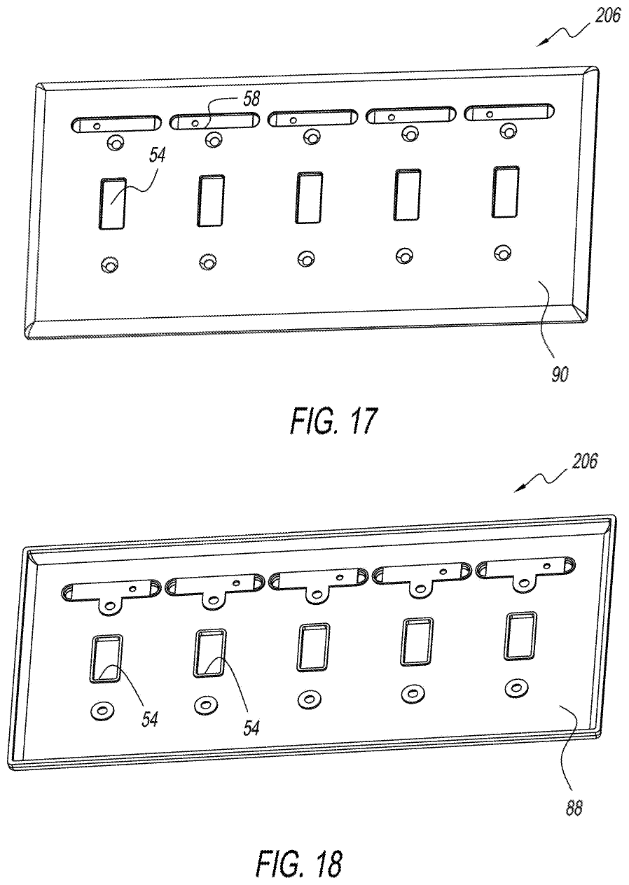

FIG. 17 is a front perspective view of a cover plate 206 designed for use with a five “gang” array of vertically oriented toggle switches. FIG. 18 is a rear view of the cover 206 of FIG. 17.

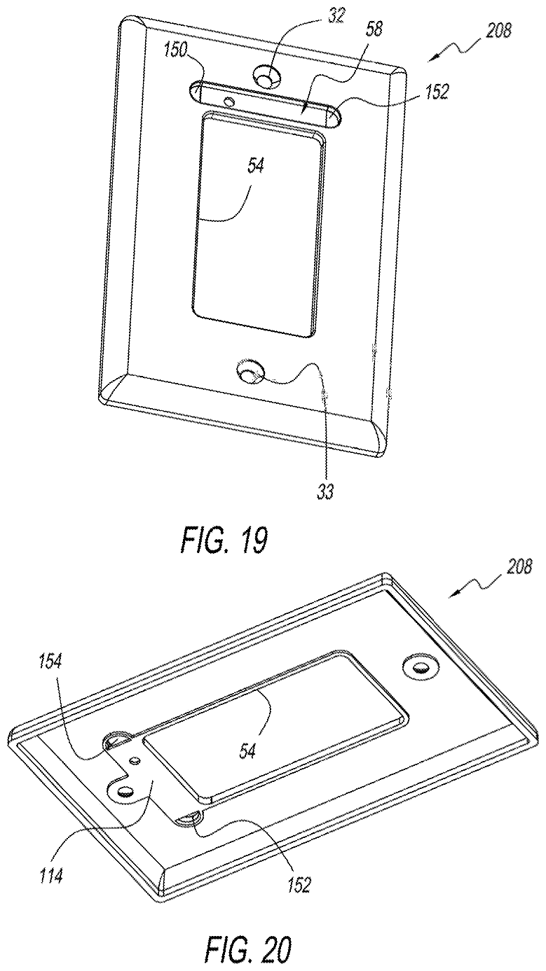

FIG. 19 is a front perspective view of a single switch cover plate 208 of the present invention intended for use with a wider switch, such as a rocker switch, a wide-type dimmer switch, a selector light switch and illuminated switch, etc., many of which are described at www.electronicshub.org/different-types-of-light-switches/the disclosure of which is incorporated herein by reference. FIG. 20 is a rear view of the cover plate 208 of FIG. 19.

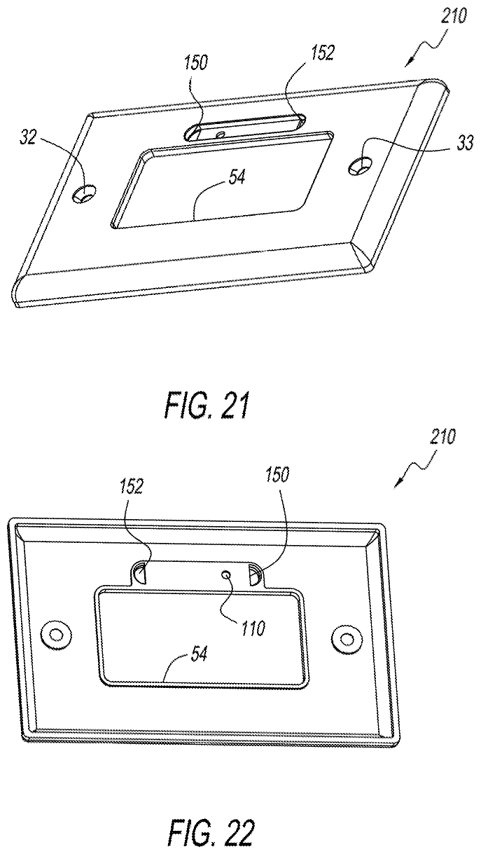

FIG. 21 is a front perspective view of a horizontally-oriented cover plate 210 for use with a wide switch. FIG. 22 is a rear view of the cover plate 210 of FIG. 21.

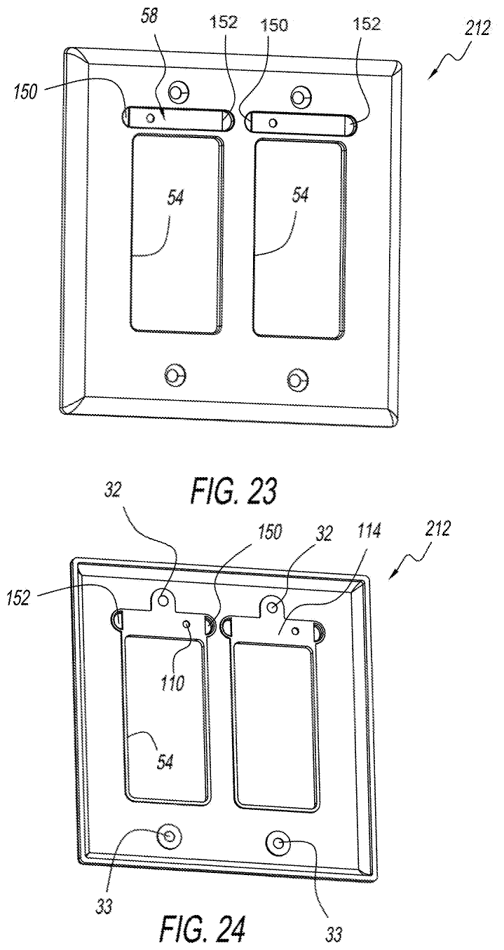

FIG. 23 is a front view of a cover plate 212 of the present invention designed for use with a pair of vertically-oriented wide switches. FIG. 24 is a rear view of the cover plate 212 of FIG. 23.

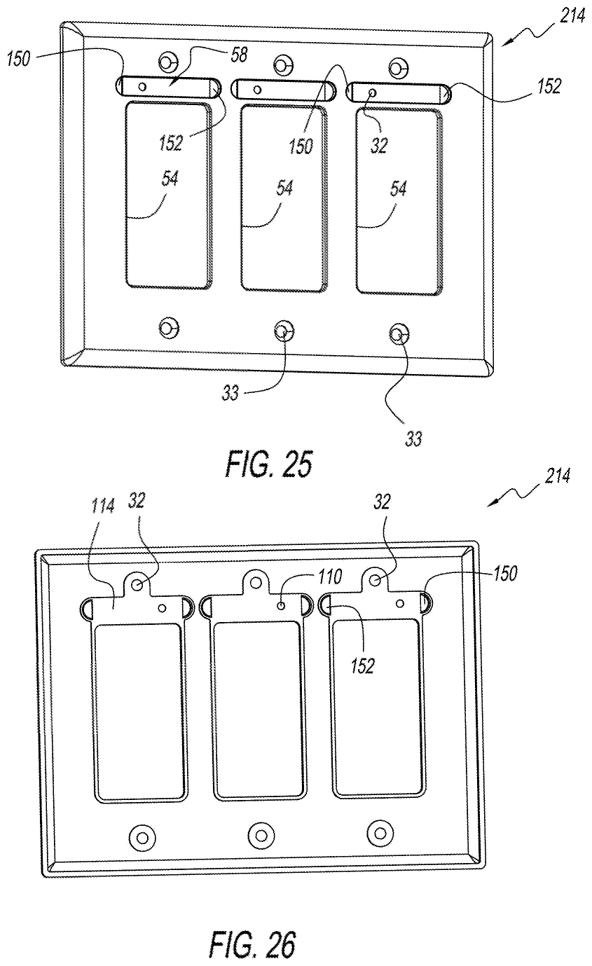

FIG. 25 is a front view of a cover plate 214 of the present invention designed for use with three vertically-oriented wide switches. FIG. 26 is a rear view of the cover plate 214 of FIG. 25;

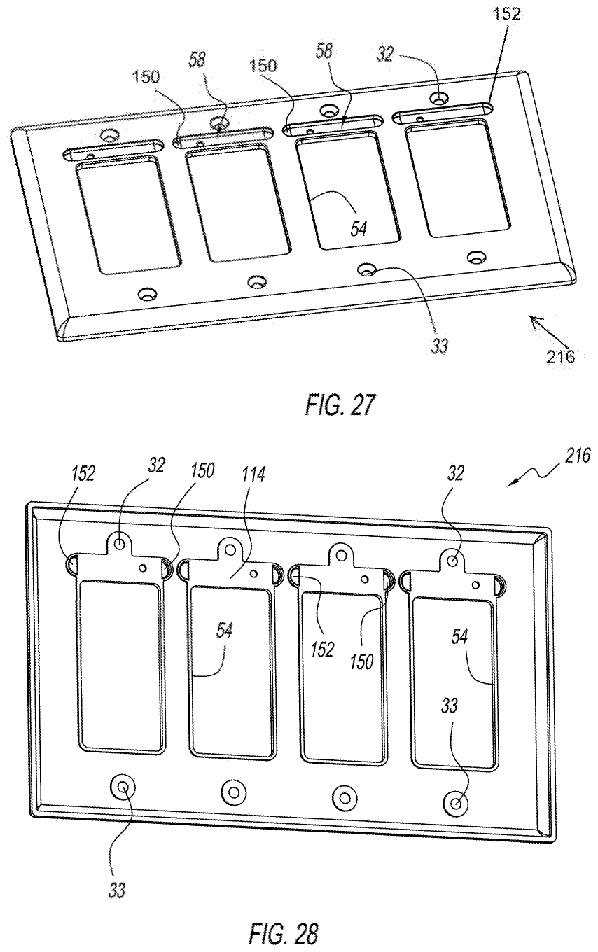

FIG. 27 is a front perspective view of a cover plate 216 of the present invention designed for use with a four-gang, vertically-oriented wide switch array. FIG. 28 is a rear view of the cover plate 216 of FIG. 27.

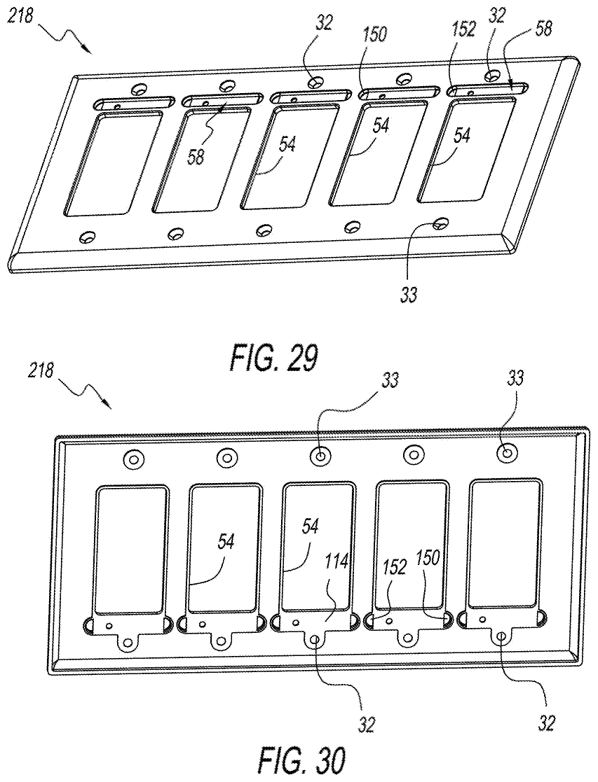

FIG. 29 is a front perspective view of a cover plate 218 of the present invention designed for a five-gang array of wide switches. FIG. 30 is a rear view of the cover plate 218 of FIG. 29.

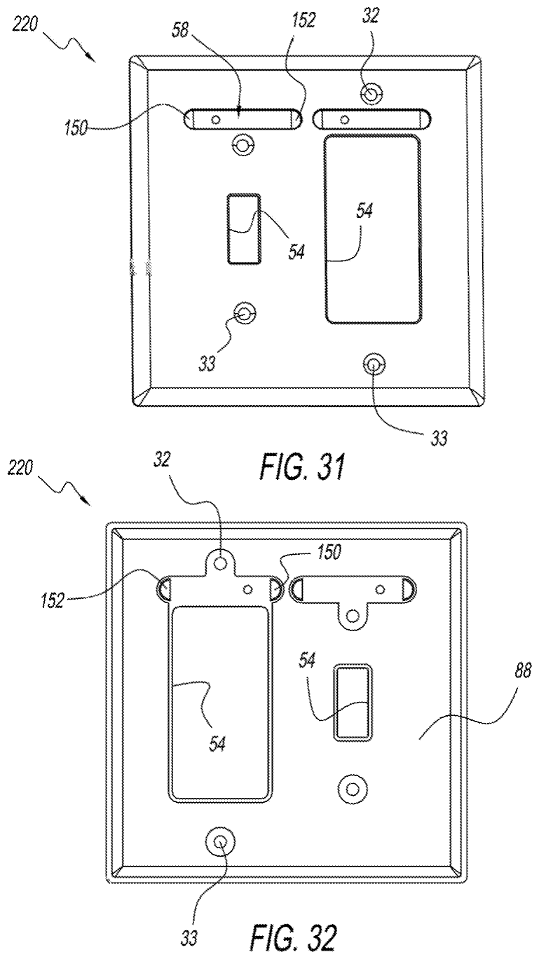

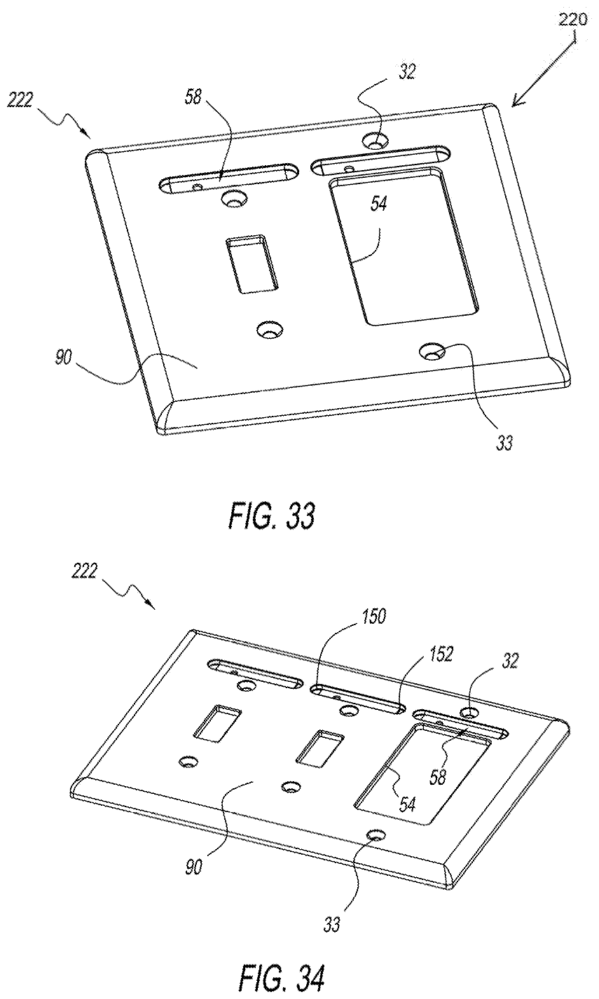

FIG. 31 is a front perspective view of a cover plate 220 designed to work with a two-gang switch, wherein the first switch is a relatively thin toggle-type switch, and the second switch is a wide-type switch. FIG. 32 is a rear perspective view of the cover plate 220 of FIG. 31. FIG. 33 is a front perspective view of the cover plate 220 of FIG. 31.

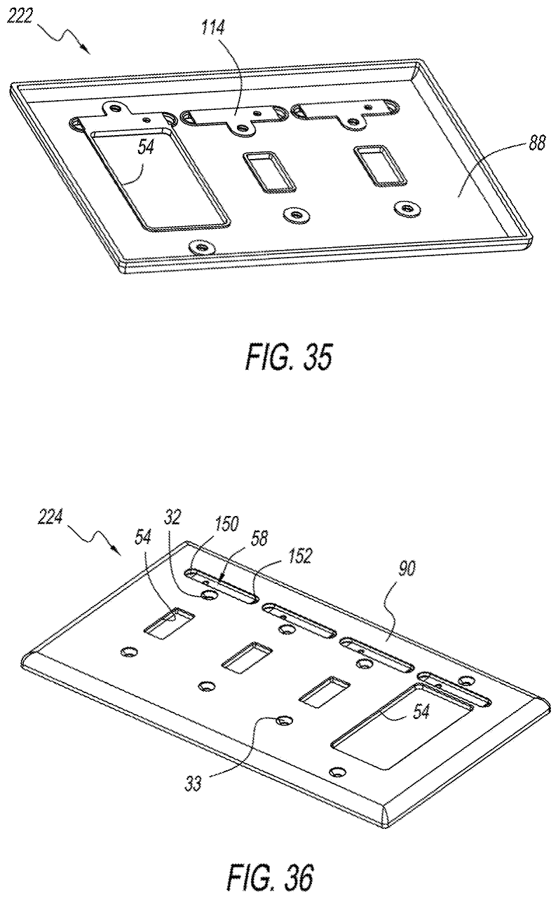

FIG. 34 is a front perspective view of a cover plate 222 designed for use with a three-gang switch, wherein the first switch of the gang is a toggle switch, the second switch is a toggle switch, and the third switch is a wide rocker-type switch. FIG. 35 is a rear perspective view of the cover plate 222 of FIG. 34.

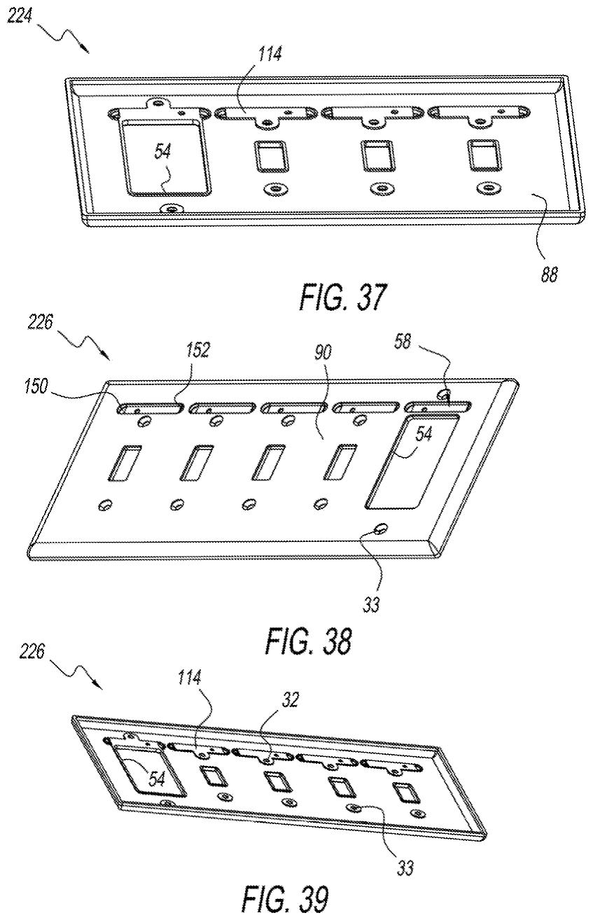

FIG. 36 is a front perspective view of a cover plate 224 of the present invention designed for use with a four gang switch, wherein the first three switches are relatively narrower toggle switches, and the fourth switch is a relatively wider rocker switch. FIG. 37 is a rear perspective of the view of the cover plate 224 of FIG. 36;

FIG. 38 is a front perspective view of a cover plate 226 of the present invention designed for use with a five-gang switch array, wherein the first four switches are toggle switches and the fifth switch is a wide switch. FIG. 39 is a rear perspective of the view of the cover plate of FIG. 38;

Having described the invention in detail with reference to certain preferred embodiments, it will be appreciated that variations and modifications exist within the invention, and that the invention is best described by the claim, with the above description and drawings not intended to be limiting to the coverage granted to the invention.

Https://netorg296269.sharepoint.com/sites/IM-IPLAWWordProcessing/Shared Documents/4202-Tom Cox-Cox and Shepherd/4202-0003 US Nonprovisional Switch Plate Cover/4202-0003-1 Apr. 2023 Electrical Switch Plate Covers with Replaceable Indicia Non-Provisional application.docx

PARTS LIST

| Part No. | Part Name |
|---|---|
| 10 | Cover plate |
| 14 | Toggle switch |
| 16 | Rocker switch |
| 18 | Housing |
| 20 | First terminal |
| 22 | Second terminal |
| 24 | Toggle switch lever |
| 26 | Metal frame |
| 28 | First screw |
| 30 | Second screw |
| 32 | First screw receiving aperture |
| 33 | Second screw receiving aperture |
| 34 | Switch moving member |
| 36 | Housing |
| 44 | Frame |
| 46 | Frame member |
| 50 | Identifying member |
| 54 | First window |
| 58 | Second window |
| 62 | Front surface of identifying member |
| 66 | Rear surface |
| 68 | ′Indicia |
| 72 | First frame engaging member |
| 74 | Second frame engaging member |
| 78 | First frame engaging leg |
| 80 | Second frame engaging leg |
| 84 | First frame engaging surface |
| 86 | Second frame engaging surface |
| 88 | Rear surface |
| 90 | Front surface |
| 96 | First end |
| 98 | Second end |
| 102 | Beveled radially outwardly facing surface |
| 104 | Radially axially facing leg |
| 108 | Pin |
| 110 | Pin receiving aperture |
| 114 | Backing plate |
| 120 | Top edge surface |
| 122 | Bottom edge surface |
| 124 | First side edge surface |
| 126 | Second side edge surface |
| 128 | Central portion |
| 130 | Perimetral portion |
| 134 | Upper wall portion |
| 136 | Lower wall portion |
| 138 | First semi-cylindrical wall portion |
| 140 | Second semi-cylindrical wall portion |
| 144 | First end of second window |
| 146 | Second end of second window |
| 150 | First slot |
| 152 | Second slot |
| 156 | Planar top side wall |
| 158 | Planar bottom side wall |
| 162 | First end wall portion |
| 164 | Second end wall portion |
| 168 | Raised character |
| 170 | Inwardly facing surface |
| 172 | Rearwardly facing surface |

What is claimed is:

1. A cover plate for an electrical switch comprising
a frame and an identifying member, the frame comprising a plate-like frame member having a first window sized and positioned for receiving at least a portion of the electrical switch, and a second window sized and configured for receiving the identifying member,
the identifying member comprising a plate-like member formed separately from the frame member, and the identifying member having a front surface and a rear surface, a indicia placeable on the front surface of the identifying member, and a frame engaging member configured for removably engaging the frame member to secure the identifying member to the frame member.

2. The cover plate of claim 1 wherein the indicia and identifying member are integrally formed.

3. The cover plate of claim 1 wherein the identifying member comprises a one piece member having an indicia formed integrally with the identifying member and comprising at least one readable character.

4. The cover plate of claim 3 wherein the second window includes a pair of slots for receiving the frame engaging member.

5. The cover plate of claim 4 wherein the frame engaging member includes a pair of tab members sized and configured for being received in the slots.

6. The cover plate of claim 5 wherein the identifying member includes a first end and a second end, and wherein the tab members comprise a first tab member adjacent to the first end, and a second tab member disposed adjacent the second end.

7. The cover plate of claim 3 wherein the second window includes a recessed cavity and a backing member that comprises at least a portion of a rear surface of the second window.

8. The cover plate of claim 7 wherein the backing member defines a first slot portion adjacent a first end of the backing member and a second slot portion adjacent a second end of the backing member.

9. The cover plate of claim 8 wherein the backing member comprises a backing plate having a substantially planar surface and wherein the identifying member includes an aligning pin extending outwardly from the rear surface of the identifying member, the aligning pin being sized and positioned to be received by a pin receiving aperture found in the backing plate.

10. The cover plate of claim 9 wherein the frame engaging member includes a first tab disposed adjacent a first end of the identifying member, and a second tab disposed adjacent a second end of the identifying member.

11. The cover place of claim 10 wherein the first tab includes a beveled radially outwardly facing surface and an axially forwardly facing frame engaging surface sized and positioned for engaging a rearwardly facing surface of the frame member, wherein the beveled surface helps the first tab move radially inwardly as the identifying member is inserted into the second window.

12. The cover plate of claim 1 wherein the second window includes a pair of slots for receiving the frame engaging member.

13. The cover plate of claim 1 wherein the frame engaging member includes a pair of tabs sized and configured for being received in the second window for coupling the identifying member to the frame member.

14. The cover plate member of claim 13 wherein the second window includes a pair of slots for receiving the pair of tabs.

15. The cover plate of claim 1 wherein the identifying member includes a first end and a second end, and the frame engaging members include a first tab member disposed adjacent to the first end of the identifying member, and a second tab member disposed adjacent to the second end of the identifying member.

16. The cover plate of claim 1 wherein the second window includes a recessed cavity and a backing member that comprises at least a portion of a rear surface of the second window.

17. The cover plate of claim 7 further comprising a backing member disposed in the second window, the backing member having a first end and a second end and defining a first slot portion disposed closer to the first end than the second end, and a second slot disposed closer to the second end than the first end.

18. The cover plate of claim 1 further comprising a backing member defining a recessed cavity in the second window, and including a pin receiving aperture, wherein the identifying member includes an aligning pin extending outwardly from the rear surface of the identifying member, the aligning pin being sized and positioned to be received by the pin receiving aperture.

19. The cover plate of claim 1 wherein the frame engaging member includes a first tab disposed closer to a first end than to a second end of the identifying member and a second tab disposed closer to the second end than to the first end of the identifying member.

20. The cover plate of claim 19 wherein the first tab includes a beveled radially outwardly facing surface, and an axially forwardly facing frame engaging surface sized and positioned for engaging a rearwardly facing surface of the frame.
